(19) United States
(12) Patent Application Publication
(10) Pub. No.: US 2007/0065799 A1
(43) Pub. Date: Mar. 22, 2007

(54) Test replication through renaming

(76) Inventors: Matthew P. Potts, Citrus Heights, CA (US); Steven Jorgensen, Newcastle, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/234,500

(22) Filed: Sep. 21, 2005

(51) Int. Cl. G09B 7/00

(52) U.S. Cl. 434/362

(57) ABSTRACT

In one embodiment, a method and system for test replication through renaming, includes the acts of: modifying a current test name of a test to a new test name; reading the new test name; sending a feedback variable indicating the new test name; and changing a stimulus or programmed featured in the test case, based upon the new test name indicated in the feedback variable. In another embodiment, an apparatus for test replication through renaming, includes various features that perform the above method.

### TECHNICAL FIELD

Embodiments of the invention relate generally to testing methods or simulation methods in a test environment, and more particularly to an apparatus and method for test replication or test modification through renaming of the test name.

### BACKGROUND

Testing of the designs of electronics devices such as, for example, network switches or other devices, are performed in order to verify the functionalities of the designs and to detect for possible defects in the designs. As known to those skilled in the art, test cases are used for testing of the design. A test case is implemented by software code and provides one or more sets of stimulus that is driven into a design-under-test (DUT) so that the design-under-test is tested for correct functionalities and possible defects.

Conventional approaches in the writing of tests for designs suffer from the following disadvantages. First, a large amount of time is spent to write similar tests. It would be beneficial to reduce the amount of time in writing similar tests. Second, a large amount of time is spent to make similar modifications to similar tests. It would be beneficial to reduce the amount of time in program modifications. Third, the likelihood of incongruencies between tests was high in current approaches. It would be beneficial to reduce such incongruencies. Prior solutions involved manually inspecting the tests and leveraging the important parts of the test. This method is time consuming, error prone, and non-intuitive.

Therefore, the current technology is limited in its capabilities and suffers from at least the above constraints and deficiencies.

### SUMMARY OF EMBODIMENTS OF THE INVENTION

In one embodiment of the invention, a method and system for test replication through renaming, includes the acts of: modifying a current test name of a test to a new test name; reading the new test name; sending a feedback variable indicating the new test name; and changing a stimulus or programmed featured in the test case, based upon the new test name indicated in the feedback variable.

In another embodiment of the invention, an apparatus for test replication through renaming, includes: a device configured to store at least one test case; a computer for permitting a user to modifying a current test name of the test to a new test name; a test launcher configured to read the new test name, and send a feedback variable indicating the new test name; and a modifying engine configured to change a stimulus or programmed featured in the test, based upon the new test name indicated in the feedback variable.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a block diagram that illustrates additional details of a test case in accordance with an embodiment of the invention.

FIG. 3 is a flowchart of a method, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

An embodiment of the invention provides various advantages. First, the need to maintain separate sets of test codes is eliminated. Second, new tests or similar tests can now be written quickly and efficiently. Third, modifications can now be made to sets of tests with less time as compared to the previous methods.

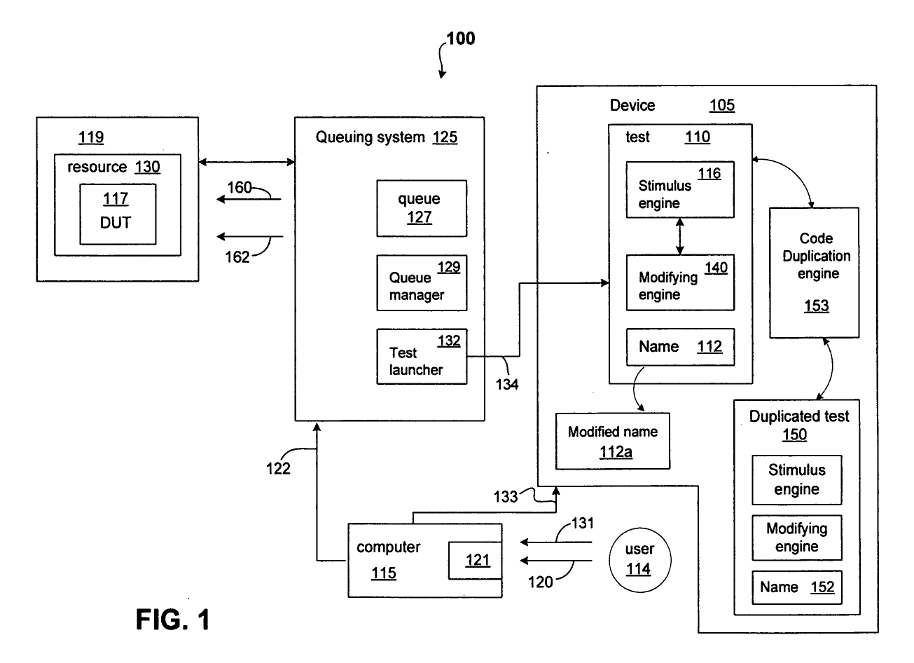

FIG. 1 is a block diagram of a system (apparatus) 100 that can use a test case (i.e., test) 110, in accordance with an embodiment of the invention. The system 100 permits test replication or test modification through renaming of the test name.

The system 100 includes a device 105 which may be, for example, a storage device, a computing device, or another suitable device that can store one or more test case 110. A test case 110 is written in a suitable programming language such as, for example, the PERL script programming language or other suitable programming language. In the example of FIG. 1, the device 105 currently stores only one test case 110, although typically more than one test case 110 is stored in the device 105. Each test case 110 corresponds to a file, and is implemented as a software code that provides stimulus for testing one or more design-under-test (DUT) 117 in a test environment 119. For example, the test case 110 is written in a specific programming language such as the PERL script programming language or other suitable programming languages.

A test case 110 includes one or more stimulus engine 116 that provides stimulus to be driven into a design-under-test (DUT) 117 in the test environment 119, so that testing is performed on the DUT 117 for proper functionalities and possible defects. Typically, a test case 110 will contain one or more stimulus engine 116, although only one stimulus engine 115 is shown in the example of FIG. 1.

The user 114 will use the computer 115 in order to select one or more test case 110 for testing one or more designs-under-test 117 in the test environment 119. It is noted that other users in the system 100 can use other computers (not shown in FIG. 1) in order to select one or more test cases 110 for testing one or more designs-under-test 117 in the test environment 119. Also, in the example of FIG. 1, the design-under-test 117 is shown as only being present in a resource 130. However, the design-under-test 117 may be present in other resources in the test environment 119. Additionally, more than one design-under-test 117 may be present in the test environment 119.

The test case 110 has a test name 112. This test name 112 is known to the user 114 of a computer 115. In the example discussed in detail below, the test name 112 of test case 110 is “[NCPU]_{—}1518U_MODEF.TC”, although other suitable test names may be used in other examples or if the test case 110 provides a different stimulus for testing a design-under-test. If the test name 112 is “[NCPU]_{—}1518U_MODEF.TC, then the test 110 provides a stimulus engine 116 that generates packets that are 1518 bytes in size. The test name 112 will differ if the test case 110 provides a different stimulus.

The user 114 selects the test case 110 for testing the design-under-test 117. The user 114 selects the test case 110 by providing a command 120 that is received and processed by a user interface 121 of the computer 115. The computer 115 sends a command 122 to a queuing system 125, and in response to the command 122, the queuing system 125 will obtain and place into a queue 127 the selected test case 110. The queuing system 125 is typically implemented by a suitable computing device such as, for example, a server or another suitable type of computing device. The queue 127 may be, for example, a memory storage space or a memory buffer. Note that the user 114 and/or other users can select additional test cases for testing the DUT 117, although in this example, the test case 110 is the only selected test case for testing the DUT 117, for purposes of clearly describing the operation of embodiments of the invention.

The queuing system 125 will then distribute the queued test case 110 to one or more resource 130 in the test environment 119. For example, the resource 130 is a computer that is used for testing a design-under-test 117. The number of resources 130 in the test environment 119 may vary.

The queuing system 125 includes a queue manager 129 which is software that will queue the jobs (i.e., distributed test cases) to be run on the resource 130 in order to test a design-under-test 117. The queue manager 129 manages the resource 130 that will run the test cases 110 so that the DUT 117 is tested. The queue manager 129 can be any suitable commercially available queue manager. Further details on the queuing of test cases for testing a DUT is described in, for example, commonly-assigned U.S. patent application Ser. No. 11/084,765, entitled “APPARATUS AND METHOD FOR DETECTING IF A TEST IS RUNNING”, by Matthew P. Potts. U.S. patent application Ser. No. 11/084,765 is hereby fully incorporated herein by reference.

In an embodiment of the invention, a test launcher 132 is in communication with the queue manager 129, so that the test launcher 132 can grab the test case 110 from the device 105 and the queue manager 129 can the distribute the test case 110 to the resource 130 so that the test case 110 is used for simulating the DUT 117. In an alternative embodiment of the invention, the functionalities of the test launcher 132 are implemented by each test case 110 so that the launcher 132 is not required to be implemented in the queuing system 125. In this alternative embodiment, the launcher 132 would be implemented as part of the test case 110.

The test launcher 132 can read the name 112 of the test 110 and can provide a variable 134 which is then fed back to a modifying engine 140 of the test case 110. The feedback variable 134 indicates the test name 112 that is read by the test launcher 132. For example, if the test name 112 is [NCPU]_{—}1518U_MODEF.TC, then the test launcher 132 can read this test name 112 and send a feedback variable 134 that indicates the test name 112. As mentioned above, the term “1518” in the test name 112 indicates that the stimulus 116 provides test packets that are 1518 bytes in size. The term “.TC” indicates that the test name 112 is for a test case file. The term “1518U_MODEF” indicates that the name of the test case 112 itself.

If the term “1518U_MODEF” were changed to “64U_MODEF” in the test name 112, then the test name 112 of “[NCPU]_{—}1518U_MODEF.TC” will change to the modified test name 112a of “[NCPU]_{—}64U_MODEF.TC”. The test launcher 132 will read this modified test name 112a and will then send back a feedback variable 134 that indicates the “64U” value in the modified test name 112a. Based on the “64U” value in the feedback variable 134, the modifying engine 140 will modify the test case 110 so that the stimulus engine 116 will now generate a new stimulus 160 of test packets that will be 64 bytes in size, instead generating the previous stimulus 162 of test packets that are 1518 bytes in size. Therefore, an embodiment of the invention permits the user to create a new test or modify a test by changing the name 112 of the test into a modified test name 112a. The invention advantageously permits the user to avoid manual re-writing of test code in order to create a new test or in order to modify a test.

The test launcher 132 is written in a suitable programming language such as, for example, the PERL script programming language or other suitable programming language. The test launcher 132 performs the required functions for launching a selected test 110. The test launcher 132 can read data from the test 110, for example, by reading the test 110 if the test is a code library or by parsing the test 110. After the launcher 132 has read data from the test 110, the launcher 132 will submit the data to the queue manager 129 so that a simulation can be performed on the DUT 117 based upon the selected test 110.

The user 114 can modify a test name 112 or can duplicate the test 110 as a new test 150 with a new test name 152 by sending commands 131 to the computer 115. In response to a user command 131, the computer 115 will send a control signal 133 that is received by the device 105, so that the device 105 creates the new test 150 which is a duplicate of the test 110. A code duplication engine 153 can create the duplicated test 150 and permits the user 114 to assign the new test name 152 to the duplicated test 150. Although the new test 152 is a duplicate of the test 110, the new test 152 will have a different name 152 which is selected by the user 114. The new test 152 can also have one or more stimulus engines, a modifying engine, and/or other code portions that are in the test 110. The functionality of the new test 152 can also be subsequently modified by the user 114 by changing the name 152 of the new test 152, in a manner similarly described above.

The benefit of being able to create one or more duplicated tests 150 is that the user can now create a large amount of tests (e.g., 500 or more tests) in a very short period of time. The duplicated or replicated tests 150 can then be modified by the user 114 by changing the test names of the duplicated tests 150. Therefore, an embodiment of the invention provides an efficient method and system for a user to create many sets of tests, without the disadvantages of prior test coding and test creation methods.

The system 100 also typically includes other components that are known and are used for permitting functions and data transmission in a network. For example, each computing device (e.g., resources 130, queuing system 125, and user computer 115) includes a processor (e.g., central processing unit) for executing software or firmware in the computing device. For purposes of focusing on the embodiments of the invention, these other known components are not shown in FIG. 1 and are not necessarily described herein.

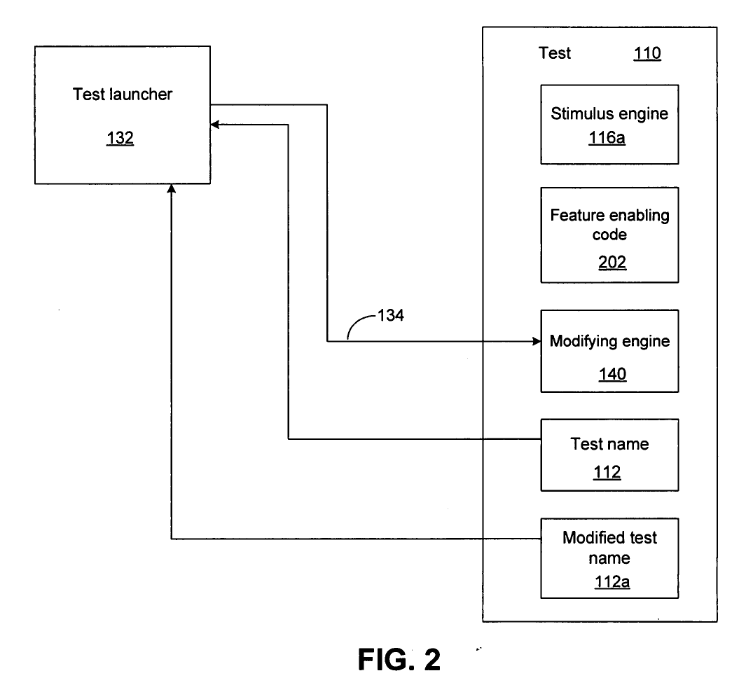

FIG. 2 is a block diagram that illustrates additional details of a test case 110 in accordance with an embodiment of the invention. The features discussed in FIG. 2 can apply to other test cases as well for simulating a DUT. When the test launcher 132 has detected that the test name 112 of the test 110 has been modified to a new test name 112a, the test launcher 132 will send a feedback variable 134 that indicates the new test name (or modified test name) 112a. The modifying engine 140 will change the test 110 based upon the feedback variable 134. For example, based upon the feedback variable 134, the modifying engine 112 may change the stimulus engine 116 so that the stimulus engine 112 will generate a stimulus of test packets in 64 bytes size instead of the previous stimulus of test packets in 1518 bytes in size. The stimulus engine 112 will modify the code in the stimulus engine 116a by parsing the code in the stimulus engine 116a and modifying the code strings for generating the packet size. If the test case 110 is implemented in the PERL programming language or other programming language, then the modifying engine 140 will be a code that performs regular expression matching by selecting strings in the code in the stimulus engine 116a. As known to those skilled in the art, regular expression matching is method for searching for a series of digits and strings in a code. The modifying engine 140 will then replace the selected strings with the feedback variable 134 related to the new test name 112a. For example, the modifying engine 140 will parse the code in the stimulus engine 116a and replace each variable 1518u in the code with the variable 64u, so that the stimulus is changed to a different packet size.

A test name 112 could also indicate another programmed feature that is performed by the test 110 and does not necessarily involve a stimulus. For example, this programmed feature in a test case 110 could include, but are not limited to, the type of calculation performed by the test, the a number of ports in the DUT 117 that will receive the stimulus from the test case 110, the packet rate of the stimulus, the parts or sections of the DUT 117 that will receive the stimulus, the data output of the DUT to be displayed to the user, particular features to be enabled or disabled in the packet traffic of the stimulus, and/or other features that can be programmed in a test case 110 as known to those skilled in the art. The test name 112 could indicate a current programmed feature of the test 110. The user can change the test name 112 to a modified test name 112a in order to change the current programmed feature to a different programmed feature.

When the test launcher 132 has detected that the test name 112 of the test 110 has been modified to a new test name 112a, the test launcher 132 will send a feedback variable 134 that indicates the new test name (or modified test name) 112a. The modifying engine 140 will change the test 110 based upon the feedback variable 134. For example, based upon the feedback variable 134, the modifying engine 112 modifies the feature-enabling code 202 in the test 110 so that a current programmed feature of the test case 110 is changed to a different programmed feature.

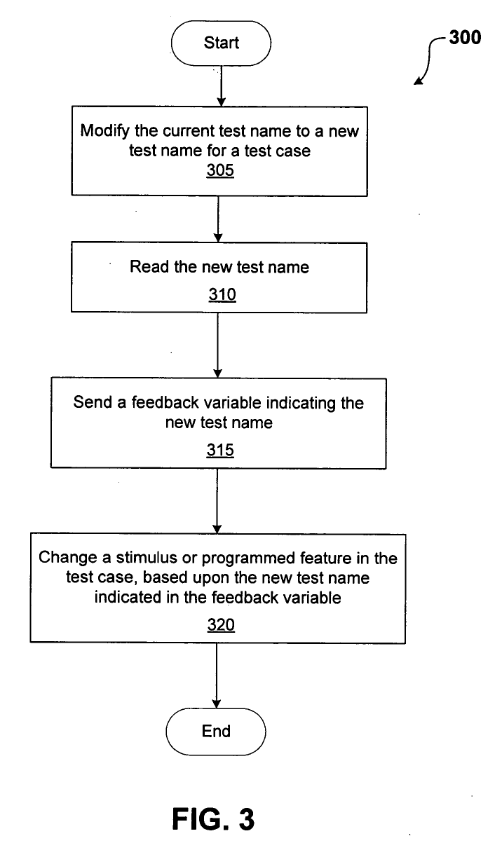

FIG. 3 is a flowchart of a method 300, in accordance with an embodiment of the invention. In block 305, a user modifies a current test name to a new test name for a test case. In block 310, the test launcher 132 reads the new test name. In block 315, the test launcher 132 sends a feedback variable indicating the new test name. In block 320, the modifying engine 140 will change a stimulus or programmed feature in the test case, based upon the new test name indicated by the feedback variable.

Therefore, an embodiment of the invention provides a method of writing tests in such a way that the behavior or functionality of the test is different depending on the name of the test. Different features or functionalities within the test can be enabled or disabled depending on the name of the test (i.e., the test name). Calculations within the test or performed by the test can also be modified by modifying the test name. To create a new test, the test will be replicated and assigned a new test name. By this method, a large numbers of tests can be written or created or modified quickly.

Various elements in the drawings may be implemented in hardware, software, firmware, or a combination thereof.

The various engines or codes discussed herein may be, for example, computer software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names (e.g., “stimulus engine”, “modifying engine” or the like) for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for test replication through renaming, the method comprising:
modifying a current test name of a test to a new test name;
reading the new test name;
sending a feedback variable indicating the new test name; and
changing a stimulus or programmed featured in the test, based upon the new test name indicated in the feedback variable.

2. The method of claim 1, wherein modifying the current test name is performed by a user.

3. The method of claim 1, further comprising:
replicating the test in order to create a new test with an associated test name.

4. The method of claim 3, wherein the associated test name is selected by a user.

5. The method of claim 1, wherein the test is used for simulation of a device-under-test.

6. The method of claim 1, wherein reading the new test name is performed by a test launcher.

7. The method of claim 1, wherein sending the feedback variable is performed by a test launcher.

8. The method of claim 1, wherein changing a stimulus or programmed featured in the test is performed by a modifying engine.

9. The method of claim 1, wherein changing the stimulus comprises changing packet traffic for simulation of a device-under-test.

10. The method of claim 1, wherein changing the programmed feature comprises changing at least one of the following: a type of calculation performed by the test, a number of ports in a device-under-test to be simulated, a packet rate generated by the test, parts or sections of the device-under-test that will receive the stimulus, a data output of the device-under-test to be displayed to the user, particular features to be enabled or disabled in a packet traffic of the stimulus.

11. An apparatus for test replication through renaming, the apparatus comprising:
a device configured to store at least one test case;
a computer for permitting a user to modifying a current test name of the test to a new test name;
a test launcher configured to read the new test name, and send a feedback variable indicating the new test name; and
a modifying engine configured to change a stimulus or programmed featured in the test, based upon the new test name indicated in the feedback variable.

12. The apparatus of claim 11, further comprising:
a code duplication engine configured to replicate the test in order to create a new test with an associated test name.

13. The apparatus of claim 12, wherein the associated test name is selected by a user.

14. The apparatus of claim 11, wherein the test is used for simulation of a device-under-test.

15. The apparatus of claim 11, wherein the modifying engine changes the stimulus by changing the packet traffic for simulation of a device-under-test.

16. The apparatus of claim 11, wherein the modifying engine changes the programmed feature by changing at least one of the following: a type of calculation performed by the test, a number of ports in a device-under-test to be simulated, a packet rate generated by the test, parts or sections of the device-under-test that will receive the stimulus, a data output of the device-under-test to be displayed to the user, particular features to be enabled or disabled in a packet traffic of the stimulus.

17. An article of manufacture, comprising:
a machine-readable medium having stored thereon instructions to:
modify a current test name of a test to a new test name;
read the new test name;
send a feedback variable indicating the new test name; and
change a stimulus or programmed featured in the test, based upon the new test name indicated in the feedback variable.

18. An apparatus for test replication through renaming, the apparatus comprising:
means for modifying a current test name of a test to a new test name;
means for reading the new test name and for sending a feedback variable indicating the new test name; and
means for changing a stimulus or programmed featured in the test, based upon the new test name indicated in the feedback variable.
